(19) United States
(12) Patent Application Publication
(10) Pub. No.: US 2007/0047007 A1
(43) Pub. Date: Mar. 1, 2007

(54) Facsimile apparatus

(75) Inventor: Miyuki Hayashi, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/388,808

(22) Filed: Mar. 24, 2006

(30) Foreign Application Priority Data
Aug. 29, 2005 (JP) 2005-247754

(51) Int. Cl. H04N 1/00

(52) U.S. Cl. 358/401; 358/501; 358/1.15

(57) ABSTRACT

A facsimile apparatus comprises: an erasing portion for entirely erasing secret information such as name of a destination or a facsimile number at the time of relocation, disposal or renewal of the facsimile apparatus; and a controller which makes the printing section print out the entire contents stored in the storage section after erasing of the entire contents is completed, and thereby secret information is erased without a burdensome operation. Further, a user can visually confirm whether the information is surely erased or not, and thereby undesirable leaking of the secret information at the time of disposal, reuse and the like is prevented in advance, and a security of information can be improved.

### BACKGROUND OF THE INVENTION

1. Field of the Invention

The present invention relates to a facsimile apparatus. More particularly, it relates to management of confidential information, such as abbreviation number registration, on disposal or replacement of a facsimile apparatus.

2. Description of the Related Art

In a storage section of a facsimile apparatus, information necessary for facsimile communication, such as an abbreviation number registration including destination names and facsimile numbers, can be stored in advance. If confidential information, such as destination names and facsimile numbers, is not properly handled when the facsimile apparatus is relocated, disposed or replaced, the confidential information is likely to leak undesirably when the facsimile apparatus is disposed or reused.

Japanese Unexamined Patent Publication No. 2001-186239 discloses a method of erasing such confidential information. According to this prior art, if operations such as modification of a circuit class or modification of a sender's number are made, a facsimile apparatus determines that it is relocated, and then, starts an initialization mode. Then, in accordance with an order selected and inputted by a user, the facsimile apparatus executes initialization of contents such as abbreviation number registrations.

However, an object of the above-described prior art is to simplify the abbreviation number registration when the facsimile apparatus is relocated to other department, and is not directed to protection of confidential information. Namely, in the case of relocating a facsimile apparatus, next location of the facsimile apparatus is likely to be within the same company. Even if information of business clients is leaked to other sections of the same company, a possibility that such leakage causes a problem is likely to be small. On the contrary, in the case of disposal or, especially, renewal due to an expiration of a lease period, there could be a high possibility that an apparatus body which has been taken away is reused. Further, there could be a high possibility that the confidential information is undesirably leaked. Thus, it is necessary to confirm whether the confidential information is erased or not.

### SUMMARY OF THE INVENTION

The present invention has worked out to solve the problem described above, and its object is to provide a facsimile apparatus which enables a user to confirm whether confidential information is erased or not.

According to an aspect of the present invention, a facsimile apparatus comprises: a storage section for storing in advance information necessary for facsimile communication; an erasing portion for entirely erasing contents stored in the storage section; a printing section for executing printing; and a controller which makes the printing section print out the entire contents stored in the storage section after the erasing of the entire contents is completed.

These and other objects, features, aspects, advantages of the present invention will become more apparent from the following detailed description of the preferred embodiments/examples with reference to the accompanying drawings.

### BRIEF DESCRIPTION OF THE DRAWINGS

FIG. 1 is a block diagram showing an electric construction of a digital composite machine which corresponds to a facsimile apparatus according to an embodiment of the invention.

FIG. 2 is a diagram representing contents of an address list stored in a data memory of the digital composite machine shown in FIG. 1.

FIG. 3 is a diagram showing an exemplary print-out representation of an address list.

FIG. 4 is a diagram showing an exemplary print-out representation of an address list in the state where the address list is entirely erased.

FIG. 5 is a diagram showing another exemplary print-out representation of an address list in the state where the address list is entirely erased.

FIG. 6 is a diagram showing yet another exemplary print-out representation of an address list in the state where the address list is entirely erased.

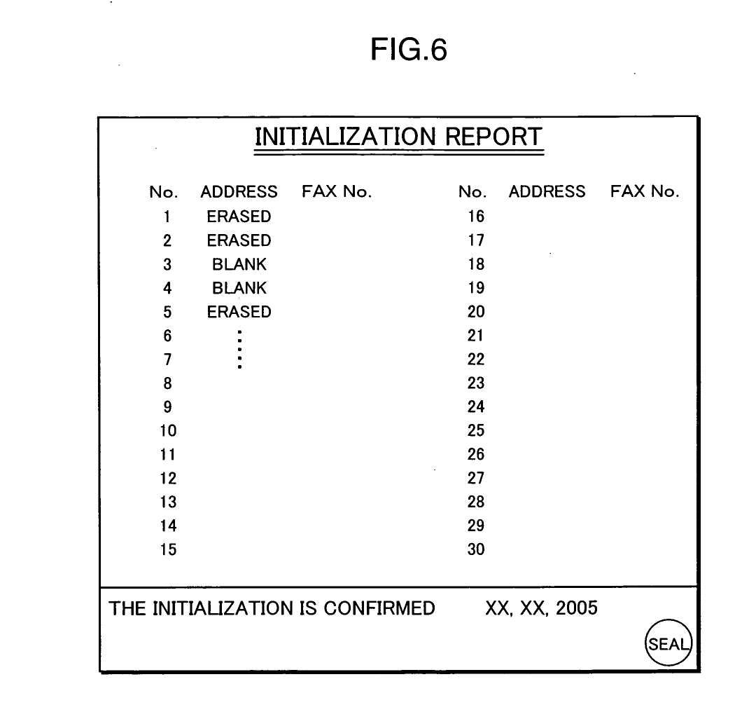

### DETAILED DESCRIPTION OF THE PREFERRED EMBODIMENTS

Hereinafter, embodiments of the present invention will be described in detail with reference to the drawings. However, it should be noted that size, shape and relative position of components described in the embodiment do not limit the scope of the present invention only to these measurements but are mere examples for explanation unless any specific descriptions are especially presented.

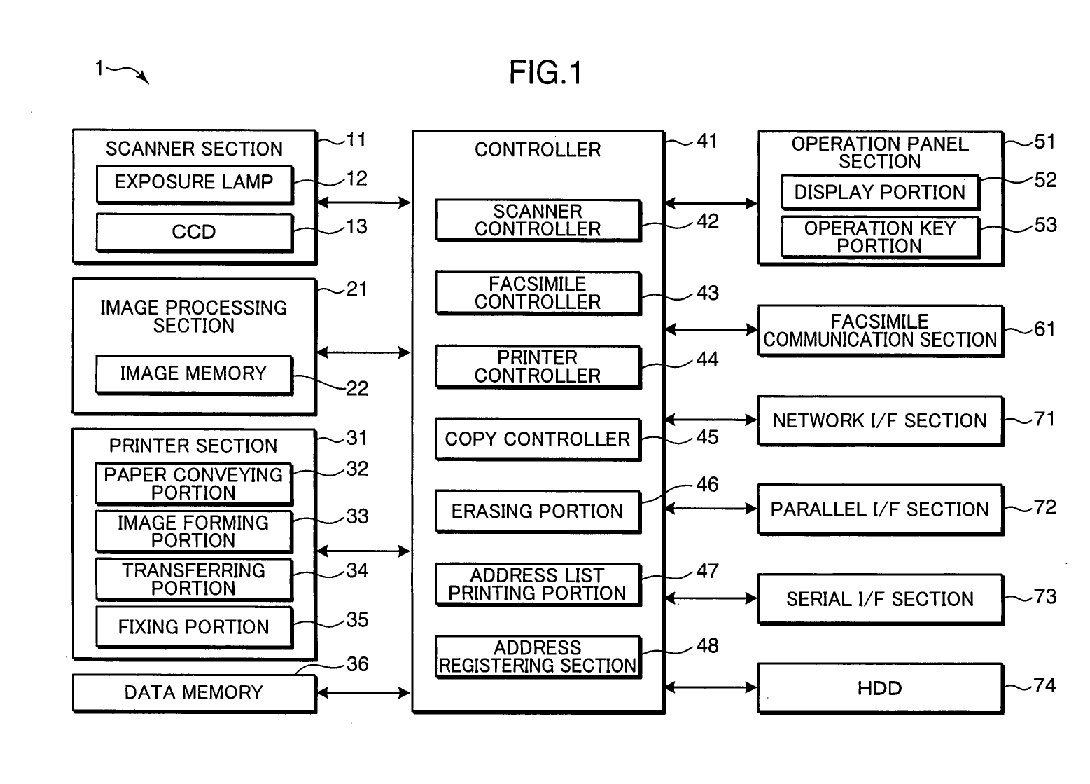

FIG. 1 is a block diagram showing an electric construction of a digital composite machine, which corresponds to a facsimile apparatus according to an embodiment of the invention. The composite machine is directed to an image forming apparatus comprising a plurality of functions related to an image forming, such as a copy function, a printer function, a facsimile function and a scanner function. This composite machine 1 schematically comprises a scanner section 11, an image processing section 21, a printer section 31, a data memory 36, a controller 41, an operation panel section 51, a facsimile communication section 61, a network I/F section 71, a parallel I/F section 72, a serial I/F section 73 and an HDD (Hard Disk Drive) 74.

The network scanner function is realized by a combination of the scanner section 11, the image processing section 21, the data memory 36, the controller 41, the operation panel section 51 and the network I/F section 71. By the network scanner function, a scanned image data is transmitted to an IP address which is designated in advance. Further, the facsimile function is realized by a combination of the scanner section 11, the image processing section 21, the printer section 31, the data memory 36, the controller 41, the operation panel section 51 and the facsimile communication section 61. Furthermore, the printer function is realized by a combination of the image processing section 21, the printer section 31, the controller 41, the operation panel section 51, the network I/F section 71 and the parallel I/F section 72. Furthermore, the copy function is realized by a combination of the scanner section 11, the image processing section 21, the printer section 31, the controller 41 and the operation panel section 51.

The operation panel section 51 allows a user to give an operation order (command) to the controller 41 to thereby execute an operation related to the copy function, the printer function, the facsimile function, the scanner function and such. The operation panel section 51 includes a display portion 52 having a touch panel, and an operation key portion 53 having a start key, a numerical keypad and such. The display portion 52 has a color-displayable touch panel unit having a combination of a touch panel and an LCD (Liquid Crystal Display) which displays various kinds of operation screens to enable an input operation. For example, when the facsimile function is executed, the display portion displays information related to a user selection, a destination selection, a transmission setting and such. Further, the display portion displays operation buttons which a user touches the relevant portions thereof to input various kinds of operation order. The operation key portion 53 is used to input various kinds of orders by a user, such as an order to initiate execution of copying or an order to initiate execution of a facsimile transmission.

The scanner section 11 obtains an image of a document optically and generates an image data. The scanner section 11 includes an exposure lamp 12 and a CCD (charge-couple device) 13. The scanner section 11 reads a document by illuminating the document with the exposure lamp 12 and receiving reflected light rays with the CCD 13. Then, it outputs an image data which corresponds to the read image to the image processing section 21. The scanner section 11 may be constructed so as to read not only a monochromatic document but also a colored document or a picture.

The image processing section 21 executes various kinds of image processing with respect to the image data. For example, the image processing section executes various kinds of image processing such as a predetermined correction processing of a level correction, γ correction and such, a compression or expansion processing and an enlargement or contraction processing with respect to the image data which is obtained by the scanner section 11 and such. The image processing section 21 includes an image memory 22. The image processing section 21 stores a processed image data and such in this image memory 22 and outputs the processed image data to the printer section 31, the facsimile communication section 61, the network I/F section 71 and such.

The printer section 31 prints on predetermined recording paper an image which corresponds to an image data. Such image data includes an image data of a document read by the scanner section 11, an image data received through the network I/F section 71 from an external personal computer and such, and a facsimile data received by the facsimile communication section 61 from an external facsimile machine. The printer section 31 includes: a paper conveying portion 32 having a paper feeding cassette and a paper feeding roller; an image forming portion 33 having an intermediate transferring body roller, a photoconductive drum, an exposing device, a developing device and such; a transferring portion 34 having a transferring roller and such; and a fixing portion 35 having a fixing roller and such. Specifically, the paper conveying portion 32 conveys recording paper to the image forming portion 33, the image forming portion 33 forms a toner image which corresponds to the above image data, the transferring portion 34 transfers the toner image to the recording paper, and then the fixing portion 35 fixes the toner image to the recording paper to form an image.

The data memory 36 is a storage section which stores in advance information necessary for facsimile communication such as destination names and facsimile numbers in an abbreviation number registration. Further, it stores in advance IP addresses of destinations which are used when the facsimile apparatus is used as a network scanner. In accordance with an input operation to the operation panel section 51, the contents stored in the data memory 36 can be desirably rewritten by the controller 41.

The controller 41 includes in a CPU (Central Processing Unit), peripheral devices of a storing section such as a RAM (Random Access Memory) and a ROM (Read Only Memory) for storing a program which determines an operation of the CPU and a RAM for temporarily storing a data. The controller 41 controls the composite machine totally in response to order information received in the operation panel section or in response to detection signals from sensors set in various parts of the composite machine 1. More specifically, the controller 41 functions as a scanner controller 42, a facsimile controller 43, a printer controller 44 and a copy controller 45.

A program which a computer as the controller 41 reads to offer the respective function described above is executed by the CPU if the program is stored in a nonvolatile and high-capacity external memory device such as an HDD 74 and is transferred accordingly to a main memory device such as the RAM. The program can be provided through a recording medium such as the ROM or CD-ROM. Further, it is also provided through a transmission medium such as a network connected through the network I/F section 71. The transmission medium is not limited to be a wired transmission medium, but it may also be a wireless transmission medium. Further, the transmission medium includes not only a communication line but also includes an intermediary device which relays the communication line, for example, a communication link such as a router.

In the case where the program is provided through a ROM, the program can be executed by CPU if the ROM storing the program is added to the controller 41. In the case where the program is provided via a CD-ROM, the program can be executed by the CPU if a CD-ROM reader is connected, for example, to the parallel I/F section 72 and the program is transferred to the RAM or the HDD 24. Further, in the case where the program is provided through a transmission medium, the program can be executed by the CPU if the program received through the network I/F section 71 is transferred to the RAM or the HDD 74.

The scanner controller 42 controls an operation of respective sections which are used for offering the scanner function. The facsimile controller 43 controls an operation of the respective sections which are used for offering the facsimile function. The printer controller 44 controls an operation of the respective sections which are used for offering the printer function. The copy controller 45 controls an operation of the respective sections which are used for offering the copy function.

The facsimile communication section 61 includes an encoding and decoding portion, a modulation and demodulation portion and an NCU (Network Control Unit). The facsimile communication section 61 transmits an image data of a document read by the scanner section 11 to other facsimile apparatus through a phone line or an internet connection and receives an image data transmitted from other facsimile apparatuses. The encoding and decoding portion compresses or encodes an image data which is to be transmitted and decompresses or decodes a received image data. The modulation and demodulation portion modulates a compressed or encoded image data into an audio signal and demodulates a received signal (audio signal) into an image data. The NCU controls a connection through a phone line with respect to a destination facsimile apparatus.

The network I/F section 71 controls various kinds of data transmission with respect to a user server connected through a network by using a network interface (for example, 10/100 Base-TX) and such. Further, in the case where one or more terminal devices such as personal computers are connected to a network, the network I/F section 71 controls various kinds of data transmission which takes place between the facsimile apparatus and these terminal devices. For example, the network I/F section 71 transmits a document image data read by the scanner section 11 to the terminal devices and receives an image data which is transmitted from the terminal devices to be print out by the printer section 31.

The parallel I/F section 72 receives a printing data and such from external equipment and such by a parallel transmission where a plurality of data is transmitted through a plurality of single lines at each time. Herein, a high speed bidirectional parallel interface, for example, which conforms to IEEE1284, is used. The serial I/F section 73 receives various kinds of data from an external equipment and such by a serial transmission where a single signal line is used to sequentially transmit 1 bit of data each time. Herein, a serial interface such as RS-232C is used.

The HDD 74 stores an image data read by the scanner section 11, an image data transmitted through the network, or an output format specified to the image data. The image data stored in the HDD 74 is not only used for the hybrid machine 1, but also used for the terminal devices if the image data is confirmed by the terminal device or transferred to a predetermined folder of the terminal device through the network I/F section 71.

Further, the composite machine 1 combines the respective functions described above to realize various kinds of functions. For example, a PC transmission function, an e-mail transmission function or a FAX transmission function may be offered as the scanner function. Herein, the PC transmission function is a function to directly send an image data read from a document to the specified terminal device through a network. The e-mail transmission function is a function to directly send an image read from a document as an attachment of an e-mail to an SMTP server which is not shown in the drawings, for example, through a network. Further, by this function, the image data read from a document is transmitted as an attachment file of an e-mail from this SMTP server to the specified external terminal device through a network. The facsimile function is a function to transmit an image data read from a document directly to the specified facsimile apparatus through a phone line.

In the composite machine 1 constructed as described above, it should be noted that the erasing portion 46 in the controller 41, which is an embodiment of the memory access portion, entirely erases the contents stored in the data memory 36, the storing section in response to a predetermined operation made to the operation panel section 51, which is an embodiment of the input portion included in the erasing portion. After the erasing of the entire contents is completed, the address list printing portion 47, which is an embodiment of the controller, makes the printer section 31, which is one of the embodiments of the printer section, print out the memory contents of the data memory 36 through the printer controller 44. At this time, IP addresses for the network scanner stored in the data memory 36 may be erased simultaneously.

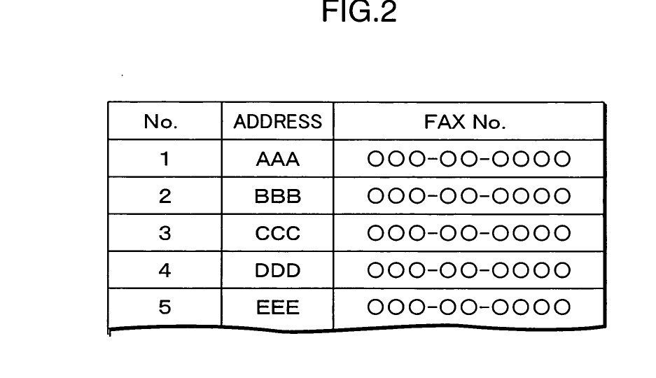

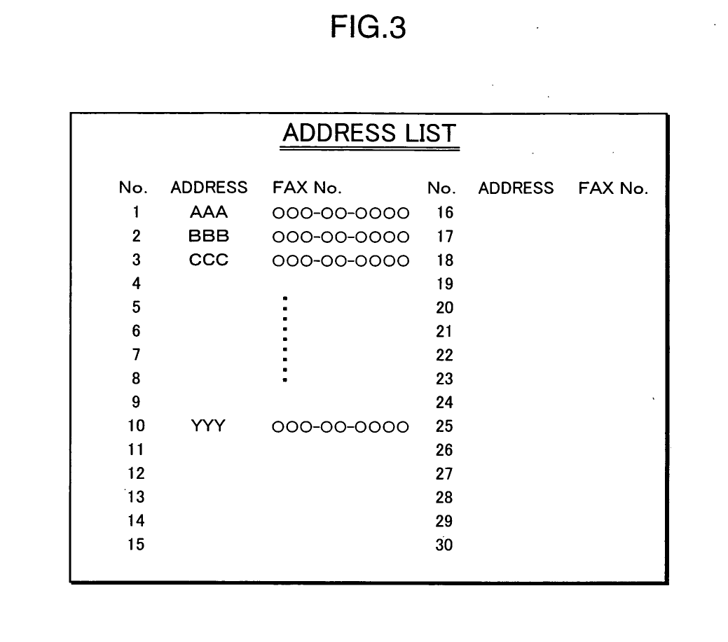

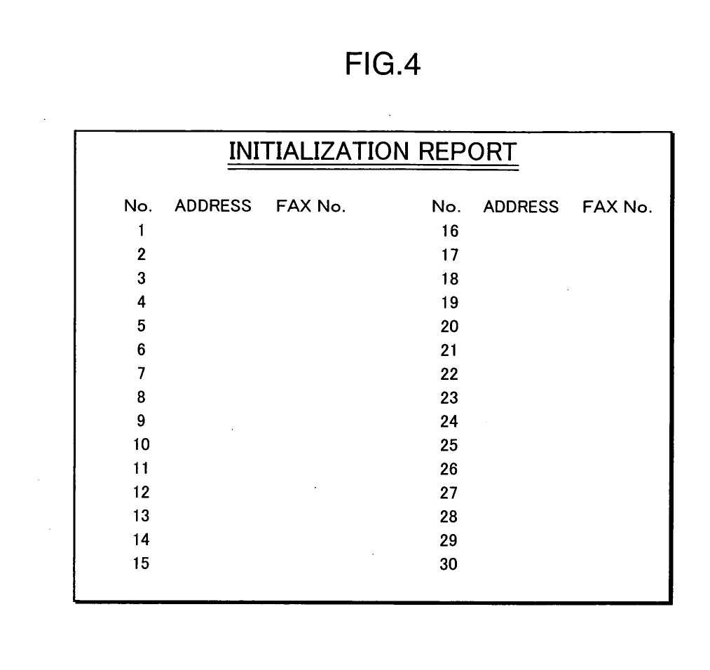

An address registering section 48 registers destination names and corresponding facsimile numbers are registered as an abbreviation number registration in the data memory 36 as shown in FIG. 2 in response to an operation made to the operation panel section 51. The contents are printed out in a form as shown in FIG. 3 by the address list printing function of the address list printing portion 47 in response to an operation to the operation panel section 51. Consequently, a user may desirably print out to confirm the contents of the abbreviation number registration. In the embodiment, when the contents are entirely erased, an initialization report as shown in FIG. 4 is printed out by using the address list printing function.

Accordingly, at the time of relocation, disposing, renewal and the like of the composite machine 1, confidential information such as contents of the abbreviation number registration can be entirely erased without a burdensome operation, and a user can confirm whether the information is surely erased or not by taking a look at the initialization report. Consequently, undesirable leaking of the confidential information at the time of disposal, reuse and such is prevented in advance, and a security of information is likely to be improved. Further, the initialization report can be created without making special software.

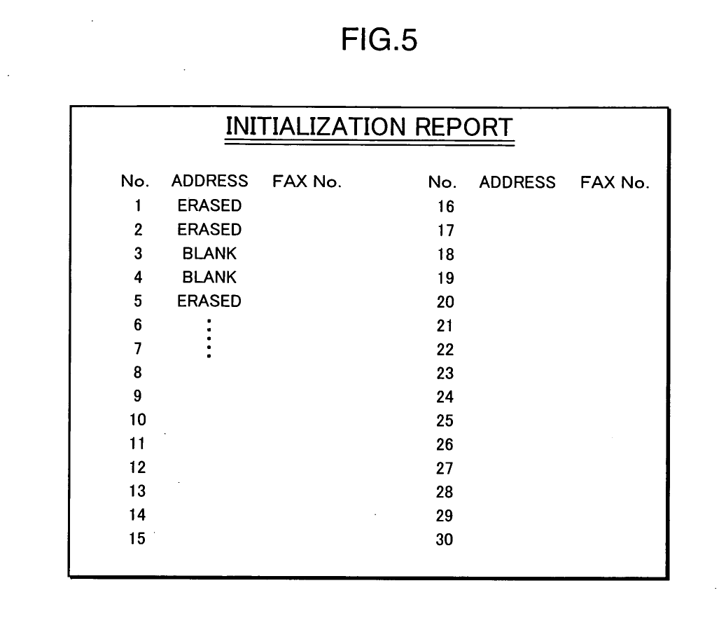

The address list printing portion 47 maybe constructed so as to print out the initialization report in such a way as to distinguish a section where no registration has been originally made (it is described “blank” as an example in FIG. 5) and a section where registration has been originally made but erased afterward (it is described “erased” in FIG. 5) instead of just leaving the erased portions blank as shown in FIG. 4. Consequently, a user may further realize that the contents are surely erased.

Further, the address list printing portion 47 may be constructed so as to print out the initialization report in such a way as to include a user signature section with the contents stored in the data memory 36. Accordingly, after confirming that the contents are surely erased, a user may sign the paper and file it with lease documents and the like. This is useful for preventing a trouble occurring at the time when the secret information is leaked. Specifically, if the information is leaked, it can be clarified that the leakage is not caused by the hybrid machine which has been taken away but leaked in other possible routes.

Furthermore, a predetermined operation for entirely erasing the contents stored in the data memory 36 is operated through an input portion such as function keys and numerical keys of the operation panel section existing in the composite machine 1. The erasing portion 46 starts an erasing mode in response to an unusual particular sequence of key operations such as a simultaneous operation of the predetermined keys or an orderly operation of the predetermined keys to access the data memory and delete the contents thereof. Thereby, undesirable erasing of data by a user's erroneous operation can be prevented, and the erasing mode can be started without a switch or button and any other special means.

In summary, a facsimile apparatus according to the embodiment of the present invention comprises: a storage section for storing in advance information necessary for facsimile communication; an erasing portion for entirely erasing contents stored in the storage section; a printing section for executing printing; and a controller which makes the printing section print out the entire contents stored in the storage section after the erasing of the entire contents is completed.

With the construction described above, in the facsimile apparatus comprising the storage section for storing in advance information necessary for facsimile communication, for example, destination names and facsimile numbers registered in an abbreviation number registration, the erasing section is provided to enable an entirely erasing of the confidential information such as the destination names and the facsimile numbers at the time of relocation, disposal or renewal. Further, the controller is provided to make the printing portion print out the entire contents stored in the storage portion as an initialization report, for example, by using the address list printing function after having the contents been erased.

Thus, secret information can be entirely erased without a burdensome operation at the time of taking the facsimile apparatus away, and a user can visually confirm whether the information is surely erased or not. Thereby, undesirable leaking of the secret information at the time of disposal, reuse and the like is prevented in advance, and the security of information can be improved.

In a facsimile apparatus according to another embodiment of the present invention, the controller makes the printing section print out a signature section on paper to be printed with the entire contents after the erasing of the entire contents is completed.

With the construction described above, at the time when the contents stored in the storage section after having been erased is printed out as an initialization report, the user signature section is also printed thereon.

Thus, after the user confirms whether the contents are surely erased, a user may sign the paper and file it with lease documents and the like. This is useful for preventing a trouble occurring at the time when the secret information is leaked. (Even if the information is leaked, it can be clarified that the leakage is not caused by the facsimile apparatus which has been taken away but leaked in other possible routes.)

In the facsimile apparatus according to the other embodiment of the present invention, the erasing portion includes: an input portion which allows an unusual particular sequence of key operations to start an erasing mode; and a memory access portion which is responsive to an output from the input portion to execute the erasing of the entire contents stored in the storage portion.

With the construction described above, the erasing portion starts an erasing mode in response to an unusual sequence of operations such as a simultaneous operation or an orderly operation of an input portion such as function keys and number keys of the input section existing in the facsimile machine. In response to the output from the input portion, the memory access portion accesses the storage portion to erase the contents stored in the storage portion.

Thus, the erasing mode can be started without a special means such as switch or button.

In the facsimile apparatus according to another embodiment of the present invention, the facsimile apparatus has a function of printing out an address list to confirm an abbreviation number registration and the controller makes the printing section print out the entire contents stored in the storage section using the address list printing function.

With the construction described above, the controller makes the printing section print out the entire contents stored in the storage section by using the address list printing function which enables the user to confirm contents of the abbreviation button registration. Thereby, the initialization report can be created without making special software.

In the facsimile apparatus according to another embodiment of the present invention, the controller makes the printing portion print out the entire contents stored in the storage portion in such a way as to distinguish a section where no registration has been originally made and a section where registration has been originally made but erased afterward.

With the construction described above, the initialization report is printed out in such a way as to distinguish a section where no registration has been originally made (it is described “blank” as an example) and a section where registration has been originally made but erased afterward (it is described “erased” as an example) instead of just leaving the erased portions blank. Thereby, a user may further realize that the contents are surely erased.

This application is based on patent application No. 2005-247754 filed in Japan, the contents of which are hereby incorporated by references.

As this invention may be embodied in several forms without departing from spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by claims.

What is claimed:

1. A facsimile apparatus comprising:
a storage section for storing in advance information necessary for facsimile communication;
an erasing portion for entirely erasing contents stored in the storage section;
a printing section for executing printing; and
a controller which makes the printing section print out the entire contents stored in the storage section after the erasing of the entire contents is completed.

2. A facsimile apparatus according to claim 1, wherein the controller makes the printing portion print out a signature section on paper to be printed with the entire contents after the erasing of the entire contents is completed.

3. A facsimile apparatus according to claim 1, wherein the erasing portion includes: an input portion which allows an unusual particular sequence of key operations to start an erasing mode; and an access portion which is responsive to an output from the input portion to execute the erasing of the entire contents stored in the storage portion.

4. A facsimile apparatus according to claim 1, wherein the facsimile has a function of printing out an address list to confirm an abbreviation number registration and the controller makes the printing section print out the entire contents stored in the storage section using the address list printing function.

5. A facsimile apparatus according to claim 1, wherein the controller makes the printing section print out the entire contents stored in the storage section in such a way as to distinguish a section where no registration has been originally made and a section where registration has been originally made but erased afterward.
